(19) United States
(12) Patent Application Publication
(10) Pub. No.: US 2018/0193764 A1
(43) Pub. Date: Jul. 12, 2018

(54) CRAFT KIT AND INSTRUCTIONS THEREFOR

(71) Applicant: GW PROPERTIES, LLC, Bristow, OK (US)

(72) Inventors: Delbert T. Sparger, Bristow, OK (US); Jennifer L. Sparger, Bristow, OK (US)

(73) Assignee: GW PROPERTIES, LLC, Bristow, OK (US)

(21) Appl. No.: 15/866,426

(22) Filed: Jan. 9, 2018

Related U.S. Application Data
(60) Provisional application No. 62/444,499, filed on Jan. 10, 2017.

(51) Int. Cl. A63H 33/10; A63H 33/04; A63H 33/30; G09B 19/10

(52) U.S. Cl. CPC A63H 33/107; A63H 33/046; G09B 19/10; A63H 33/108; A63H 33/30; A63H 33/048

(57) ABSTRACT

A craft kit (100) of separate parts adapted for assembly into an article and instructions therefor is described. The craft kit (100) includes a frame part (110) in the form of a handgun shape, the frame part (110) including a stock (112), a barrel (114), a hammer (113), and a trigger (115) integral therewith, and a pair of grip-shaped parts (120), each fixedly attachable via first fastening means to a respective side of the stock (112) on the frame part (110). The craft kit (100) includes a pair of semi-cylindrical shaped firing cylinder halves (130), each firing cylinder half (130) attachable via second fastening means to a respective side of the frame part (110). Each of the frame part (110), grip-shaped parts (112) and firing cylinder halves (113), together with the first and second fastening means, comprise the entirety of a non-lethal, handgun-shaped article assembled from the craft kit (100).

### BACKGROUND

### Field

The example embodiments in general are directed to a craft kit for assembly, and instructions therefor, more particularly to a craft kit for assembling a non-lethal, handgun shaped article therefrom and to the assembly method thereof.

### Related Art

FIG. 1 is a perspective view and FIG. 2 is an exploded parts view of a conventional craft kit to be assembled into an article, here shown as a toy-like firearm. The kit 10 includes a barrel 11 including two barrel side pieces 12a and 12b, a stock piece 15 coupled thereto, and a front barrel piece 17. Barrel 11 is designed to receive and target ammunition which can be in the form of a rubber band 90. Stock 15 also has a hole to receive a band post 19 therein. A front barrel section 17 fits between the barrel side pieces 12a and 12b and is also disposed adjacent to the stock 15.

There are also two rear barrel sections 20a and 20b of substantially rectangular cross-section coupled to outer surfaces of barrel sections 12a and 12b to act as spacers for rubber band 90. A trigger section includes a trigger 42 and a trigger wedge 44. The first end 42a of trigger 42 forms the finger contact point for a user. The second end 42b is used as a band 80 contact point, with band 80 held by posts 19, 21. This angled end is designed to accommodate band 80 as it extends across a back end of the gun resulting from assembly of kit 10. The trigger wedge 44 can be coupled to stock 14 and used for an inside handle section 50.

The handle section 50 is in the form of multiple blocks which can be coupled together. First block 52 is a main block section that is trapezoidal in shape having two substantially parallel sides and two opposite ends that are not parallel to each other. There are also a plurality of outer blocks which 54a, 54b, 54c, and 54d which can form front and back blocks on both sides of first block 52. Additional bottom handle blocks 56a and 56b are coupled to a bottom section of main handle block 52 below outer blocks 54a, 54b, 54c, and 54d to form a butt of the gun. There are also inner cover blocks 58a and 58b which can be coupled to first or base block 52. Inner cover blocks 58a and 58b are shaped so that they can be coupled to main block 52 while still providing an area for a trigger to slide.

This conventional craft kit is quite complex to assemble by a person such as a youth, having over 19 individual pieces for assembly. Accordingly, what is desired is a simpler craft kit for an article that may be assembled much more easily, with less complexity.

### SUMMARY

An example embodiment is directed to a craft kit of separate parts adapted for assembly into an article. The craft kit includes a frame part in the form of a handgun shape, the frame part including a stock, a barrel, a hammer, and a trigger integral therewith, and a pair of grip-shaped parts, each fixedly attachable via first fastening means to a respective side of the stock on the frame part. The craft kit includes a pair of semi-cylindrical shaped firing cylinder halves, each firing cylinder half attachable via second fastening means different from the first to a respective side of the frame part. Each of the frame part, grip-shaped parts and firing cylinder halves, together with the first and second fastening means, comprise the entirety of the assembled article.

Another example embodiment is directed to a craft kit for assembling a non-lethal, handgun shaped article. The craft kit includes a frame part shaped in the form of a handgun profile, a pair of grip-shaped parts fixedly attachable to a handle portion of the frame part, a pair of semi-cylindrical shaped firing cylinder halves, each attachable to a respective side of the frame part, and a set of instructions for putting the frame part, grip-shaped parts and firing cylinder halves together.

Another example embodiment is directed to a method for assembling a non-lethal, handgun shaped article. In the method, each of a pair of handle grips is coupled to either side of a first portion of a frame part designed in the form of a handgun shape. Also, each of a pair of semi-cylindrical shaped firing cylinder halves is attached to respective sides at a second portion of the frame part in order to complete assembly of the non-lethal, handgun shaped article.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 is a perspective view of a toy-like firearm assembled from parts of a conventional craft kit.

FIG. 2 is an exploded parts view of the conventional craft kit for assembling the toy firearm of FIG. 1.

FIG. 3 is a perspective view of an article assembled from a craft kit according to an example embodiment.

FIG. 4 is an exploded parts view of the craft kit according to the example embodiment.

FIG. 5 is a left-side elevational view of the frame part in the craft kit according to the example embodiment.

FIG. 6 is a perspective view of the grip-shaped part in the craft kit according to the example embodiment.

FIG. 7 is a right-side elevational view of the grip-shaped part shown in FIG. 6.

FIG. 8 is a rear plan view of the grip-shaped part shown in FIG. 6.

FIG. 9 is a perspective view of the firing cylinder half in the craft kit according to the example embodiment.

FIG. 10 is a front plan view of the firing cylinder half of FIG. 9.

FIG. 11 is a left-side elevational view of the firing cylinder half of FIG. 9.

FIG. 12 is an illustration for describing a preparatory sanding step according to a method of assembling a non-lethal, handgun shaped article from the parts of the craft kit according to the example embodiment.

FIG. 13 is an illustration for describing a coupling step of the grip-shaped parts to the frame part according to the method of assembling the non-lethal, handgun shaped article from the parts of the craft kit.

FIG. 14 is an illustration for describing an attaching step of the firing cylinder halves to the frame part according to the method of assembling the non-lethal, handgun shaped article from the parts of the craft kit.

FIG. 15 is a left-side view of the assembled non-lethal, handgun shaped article resultant from the assembly method.

FIG. 16 a right-side elevational view of another example assembled non-lethal, handgun shaped article resultant from the assembly method.

FIG. 17 a left-side elevational view of another example assembled non-lethal, handgun shaped article resultant from the assembly method.

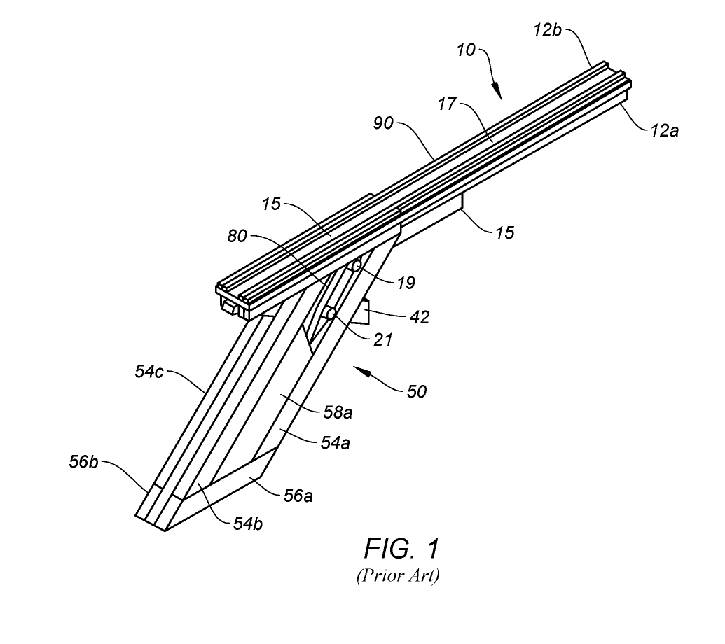

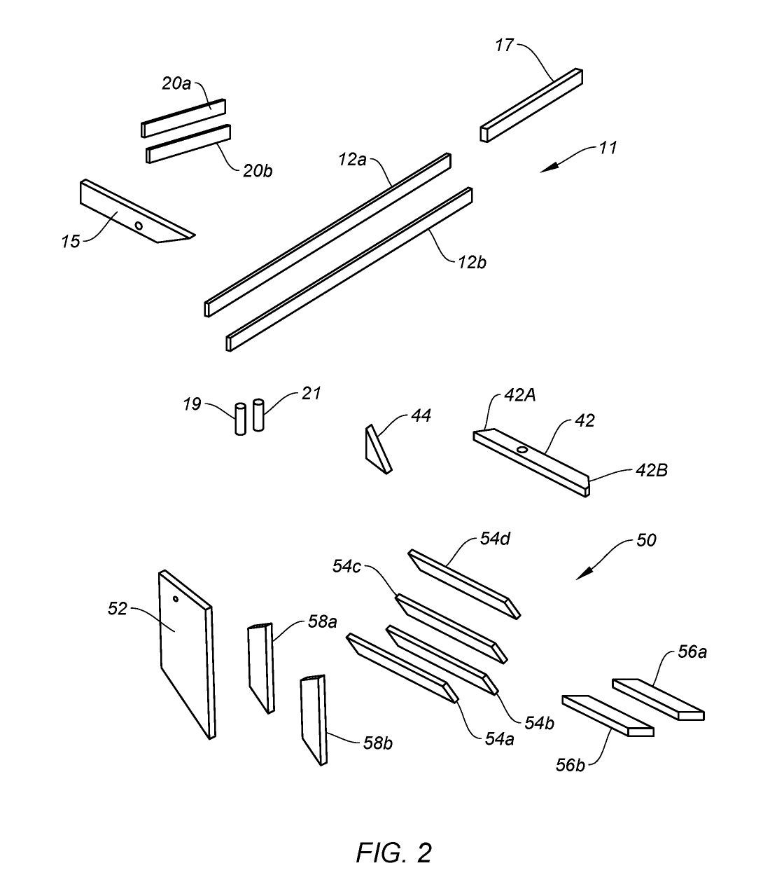

### DETAILED DESCRIPTION

In the following description, certain specific details are set forth in order to provide a thorough understanding of various example embodiments of the disclosure. However, one skilled in the art will understand that the disclosure may be practiced without these specific details. In other instances, well-known structures associated with manufacturing techniques have not been described in detail to avoid unnecessarily obscuring the descriptions of the example embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

As used in the specification and appended claims, the terms “correspond,” “corresponds,” and “corresponding” are intended to describe a ratio of or a similarity between referenced objects. The use of “correspond” or one of its forms should not be construed to mean the exact shape or size. In the drawings, identical reference numbers identify similar elements or acts. The size and relative positions of elements in the drawings are not necessarily drawn to scale.

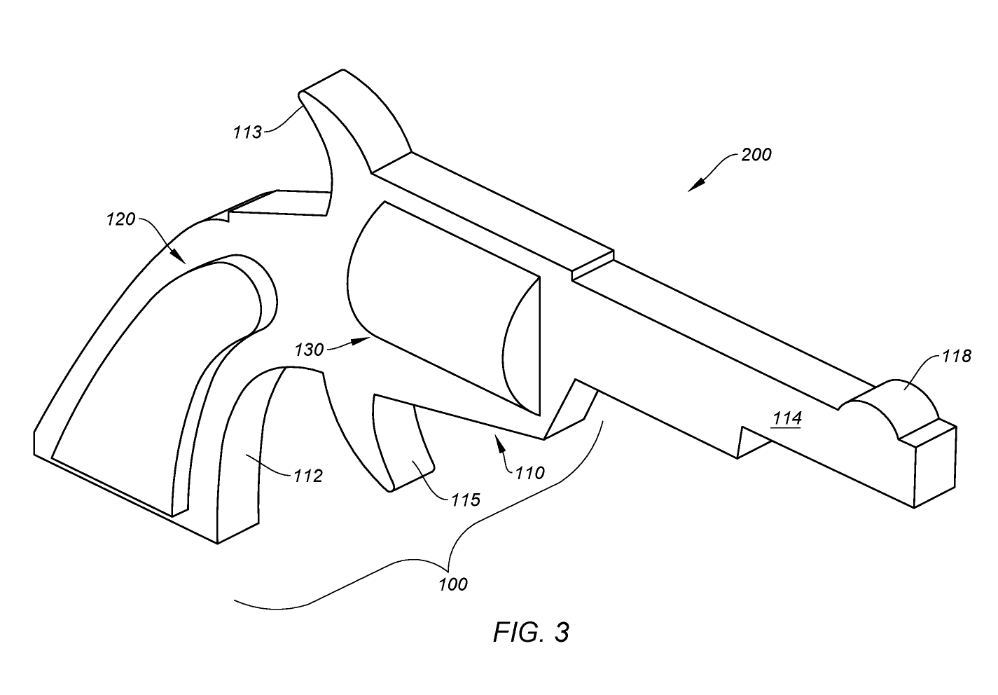

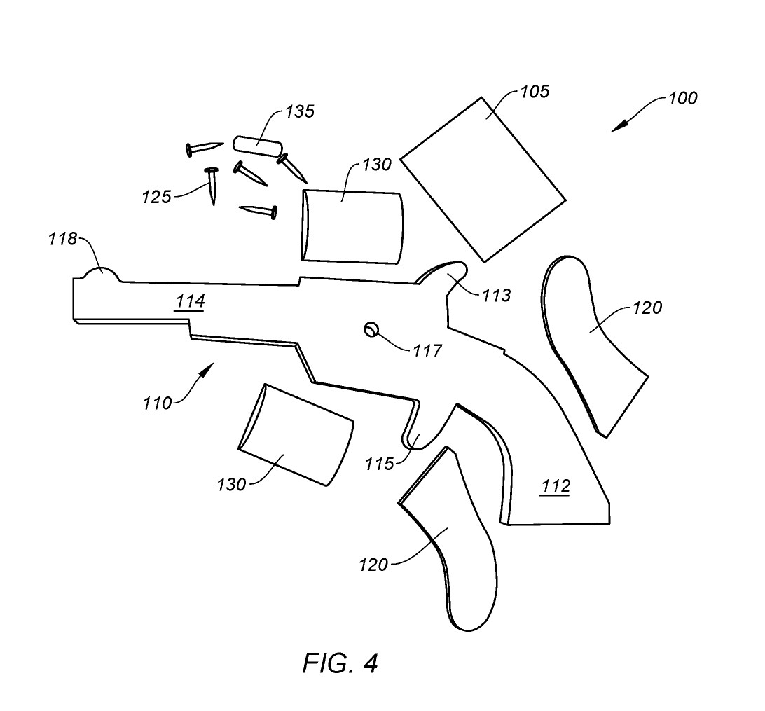

The example embodiment described more fully below envisions an attractive craft kit 100, the parts thereof adapted to be assembled into a non-lethal, handgun shaped article 200, and an assembly method therefor. Referring now to FIGS. 3-11, the example craft kit 100 includes a frame part 110 shaped in the form of a handgun (in this example, a revolver). The frame part 110 includes a stock 112 (which may be referred to herein also as a “first portion” of frame part 110), a barrel 114, a hammer 113, and a trigger 115 integral therewith, as best shown in FIGS. 3 and 4. Optionally, frame part 110 includes a front sight 118. Craft kit 100 additionally includes a pair of grip-shaped parts 120, each fixedly attachable via first fastening means to a respective or corresponding side of the stock 112 on the frame part 110, and a pair of semi-cylindrical shaped firing cylinder halves 130, each firing cylinder half 130 attachable via second fastening means different from the first to a respective or corresponding side of the frame part 110.

As best shown in FIGS. 3 and 4, the frame part 110, grip-shaped parts 120, and firing cylinder halves 130, together with the first and second fastening means (these fastening means are internal, not shown in FIGS. 3-11), comprise the entirety of the assembled non-lethal, handgun shaped article 200. Of note, the article 200, which in the shape of a handgun style such as a standard revolver, a small frame “snub-nose”-style revolver, military-style semi-automatic handguns, and the like, is merely ornamental and is not at all designed or capable of firing on type of projectile, pellet, bb, rubber band, or any other item through, around or over the barrel 114.

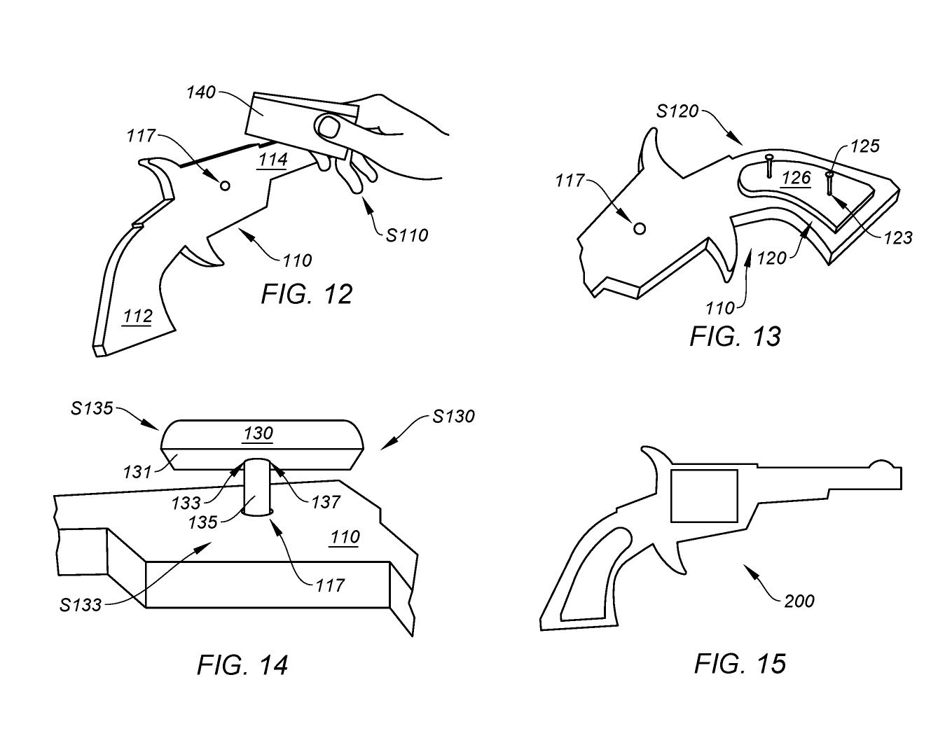

As best shown in FIG. 6, each grip-shaped part 120 includes a planar flat bottom end 121, a thickness t and a curved top end 122. As shown in FIGS. 7 and 8, each grip-shaped part 120 additionally has one or more pre-drilled holes 123 therethrough, an inner side face 124 and external face 126. As to be shown later in FIGS. 12-15 in describing a method of assembly, the first fastening means may include one or more fasteners 125, embodied as at least one or more nails (FIG. 4), brads, screws, hook-and-loop fasteners (VELCRO®), rivets, magnets, and the like. Fasteners 125 are adapted to secure the grip-shaped parts 120 to the stock 112 via the pre-drilled holes 123. In an example, the first fastening means may further include (or as an alternative to the above exemplary fasteners) an adhesive, such as a glue or epoxy, that is applied to opposed contact faces of one or both the stock 112 and grip-shaped part 120.

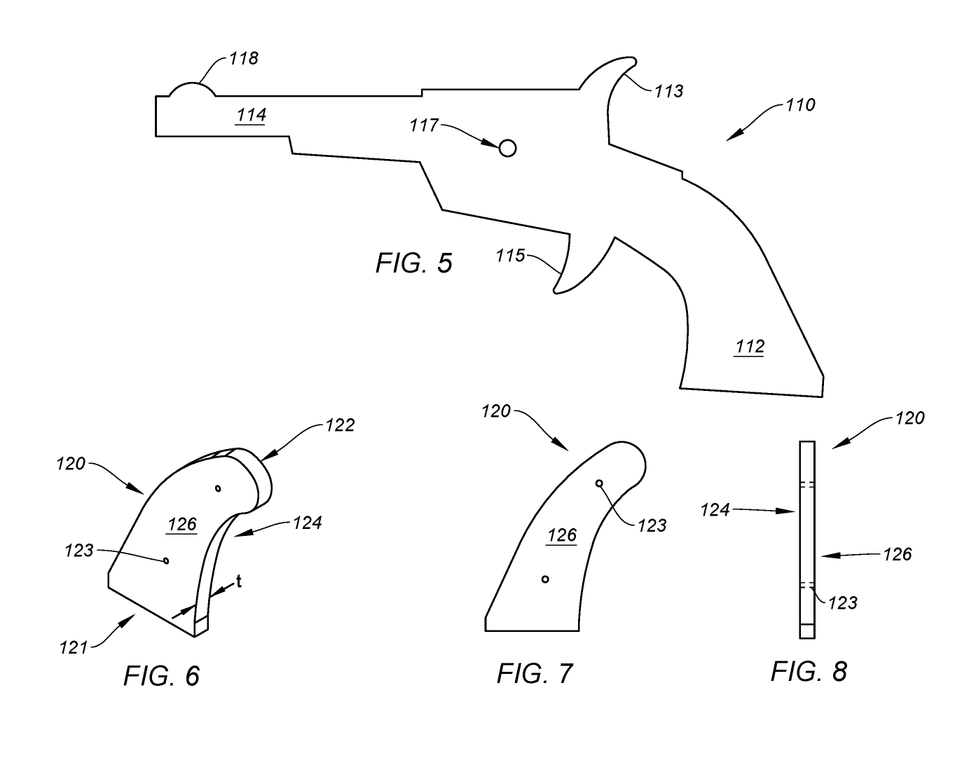

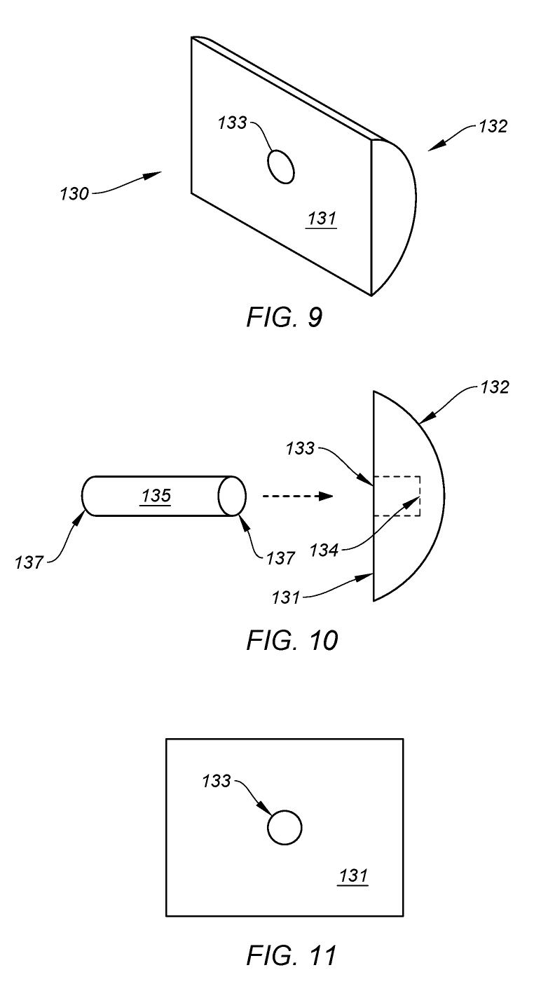

As shown in FIGS. 5 and 9-11, each firing cylinder half 130 includes a curved outer surface 132 and a central bore 133 formed partially into an inner side face 131 thereof. The frame part 110 includes a central hole 117 formed completely therethrough. Central hole 117 is adapted to be aligned with the bores 133 in the two firing cylinder halves 130. As to be described more fully below in FIGS. 12-15 illustrating the method of assembly, the second fastening means may be embodied as or include an elongate dowel 135 (see FIGS. 4 and 9). The dowel 135 is to be inserted through the frame central hole 117 between the opposed bores 133, with each bore 133 retaining an opposed end 137 of the portion of dowel 135 that protrudes from either side of frame part 110 therein, thereby securing the pair of firing cylinder halves 130 to the frame part 110. The friction generated between contact of the dowel 135 out surface and the interior wall surface in each bore may serve to secure the firing cylinder halves 130 to the frame part 110, for example. More specifically, and as best shown by FIG. 10, as a cylinder half 130 is pushed along dowel 135 until its inner side face 131 contacts frame part 110, the outer surface of each exposed end 137 of dowel 135 is captured into its bore 133, to seat against a rear face 134 of the bore 133.

In an example, the second fastening means may be embodied as or further include (and/or as an alternative to the above friction-based configuration) an adhesive, such as a glue or epoxy, that is applied to one or more of the dowel 135 within the central hole 117 in the frame part 110, within the bores 133 of the firing cylinder halves 130, on the inner side faces 131 of the cylinder halves 130, and to a portion (also referred to as a “second portion”) of the frame part 110 to be in contact with the inner side face 131 of the cylinder half 130. In another example, one or both of the first or second fastening means may comprise magnetic elements placed within the stock 112, grip part 120, bores 133 of the cylinder halves 130 and exposed ends 137 of the dowel 135, each magnet having maximum magnetic attraction in the vicinity of its counterpart.

In one example, at least one or more of the frame part 110, grip-shaped parts 120, and firing cylinder halves 130 are composed of wood or a wood-based material. In another example, component parts 110, 120 and/or 130 may be composed of a plastic or synthetic material. As a specific example, component parts 110, 120 and/or 130 may be constructed primarily from lightweight moldable plastic materials such as moldable plastic, e.g., as a single or multiple parts formed by an injection molding process using a high impact plastic such as Acrylonitrile Butadiene Styrene (ABS). ABS is an easily machined, tough, low cost rigid thermoplastic material with high impact strength, and may be a desirable material for turning, drilling, milling, sawing, die-cutting, shearing, etc. Virgin ABS may be mixed with a plastic regrind of ABS or another lightweight, durable plastic material.

ABS is merely an example plastic or synthetic material, equivalent materials may include various natural or synthetic rubber, elastomeric materials, of thermoplastic and/or thermoset materials such as talc-filled polypropylene, high strength polycarbonates such as GE LEXAN®, or of blended plastics. There are many known injection molding machines for forming plastic injection molds, other plastic molding processes such as vacuum forming may be used.

In another example, one or more of the constituent parts of craft kit 100 may be formed of a metal such as steel, aluminum, and/or alloys of steel or aluminum using various know metalworking processes. These processes include but are not limited to CNC machining, sand casting, permanent mold casting, die casting, investment casting, ablation casting, closed-die forging, by extrusion, by cold heading, by stamping & deep drawing, via a screw machine, and through powder metallurgy, for example. It follows that the skilled artisan would recognize that the constituent parts of craft kit 100 may further be composed of a combination or one or more of wood, plastic, and/or metal materials, composites or alloys thereof, and the like.

FIGS. 12-15 are illustrations for describing exemplary steps of assembling a non-lethal, handgun shaped article 200 from the constituent parts 110, 120, 130 of the craft kit 100 according to the example embodiment. In FIG. 12, there is shown a preparatory sanding step S110 according to the method. Here, all edges of the frame parts 110 are sanded until smooth and rounded.

FIG. 13 shows a step of coupling (S120) each of the grip-shaped parts 120 (or “handle grips”) to either side of a first portion (e.g., on stock 112) of the frame part 110. This may be done by initially centering each grip-shaped part 120 on the corresponding side of the stock 112 (“first portion” of frame part 110). An adhesive such as a glue or epoxy may be optionally applied on the inner surface 124 of the grip-shaped part 120, and/or on the facing surface of the stock 112 where the inner surface 124 of grip-shaped part 120 is to be affixed. Step S120 further includes inserting one or more fasteners 125 through the pre-drilled holes 123 and into the stock 112 and hammering the fasteners 125 to fixedly secure the grip-shaped parts 120 to the stock 112. Here the fasteners 125 are embodied as nails, it being understood that fasteners 125 may be embodied as any of brads, screws, hook-and-loop fasteners (VELCRO®), rivets, magnets, and the like. Step S120 may further include (in addition to or in lieu of using fasteners 125) pressing the grip-shaped parts 120 to the stock 112 of the frame part 110 for a given period of time to cure or facilitate curing of the adhesive.

FIG. 14 is an illustration for describing the step of attaching the firing cylinder halves 130 to the frame part 110 according to the assembling method. Here, the attaching step S130 comprises attaching each semi-cylindrical shaped firing cylinder half 130 to a respective side, at a “second portion” of frame part 110 (as shown, the portion of frame part 110 above the trigger 115 between the hammer 113 and barrel 114) in order to complete assembly of the non-lethal, handgun shaped article 200. The attaching step S130 may further include initially inserting the elongate dowel 135 through the frame central hole 117 (step S133). This is done so that an equal portion of the ends 137 of dowel 135 are protruding out central hole 117 on either side of the frame body 110. Next, each cylinder half 130 is attached to a respective dowel end 137 (step S135) so that each dowel end 137 is captured snugly in its corresponding bore 133. Step S135 may be accomplished by pushing the cylinder half 130 along dowel 135 toward the frame part 110 to seat its corresponding end 137 in bore 133.

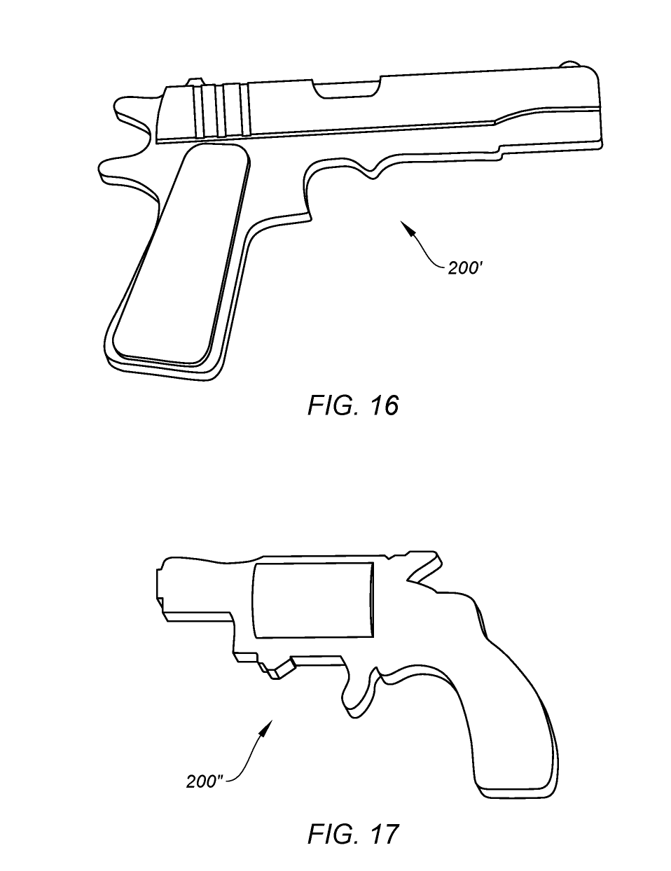

Optionally, step S130 may include applying an adhesive to one, some or all of the inner side surface 131 of the cylinder half 130, the dowel 135 itself, within bores 133, on the opposed surface of the frame part 110, and/or within central hole 117, and then pressing the cylinder halves 130 along the dowel 135 against the frame part 110 for a given period of time to cure the adhesive. This completes the assembly method; FIG. 15 shows a non-lethal, handgun-shaped article 200 resultant from the assembly method for craft kit 100. In this example, the non-lethal, handgun-shaped article 200 of FIG. 15 is a profile of a circa 1873 Cowboy Army revolver. FIGS. 16 and 17 show additional non-lethal, handgun-shaped articles that may be assembled according to the example method, including a military-style semi-automatic handgun article 200′ and a snub-nosed revolver style handgun article 200″.

It should be understood that the profile of the non-lethal, handgun-shaped articles 200, 200′, 200″ assembled from the craft kit 100 can be of any handgun-shaped style, including but not limited to: single-shot pistols such as the DERRINGER™ and the Thompson/Center ENCORE®; multi-barreled handguns such as pepper box guns, the .577 SNIDER™ and the .476 ENFIELD®; single and double action revolvers such as the .44 MAGNUM®, .45 Long COLT®, COLY 1911 .45, and .357 MAGNUM; semi-automatic handguns such as the 92 BERETTA®, SMITH & WESSON® .45, ACP™, BROWNING® 9 MM High Power, TEC-9®, and the DESERT EAGLE®; and fully automatic handguns or machine pistols such as the BERETTA 93R.

The present invention, in its various embodiments, configurations, and aspects, includes components, systems and/or apparatuses substantially as depicted and described herein, including various embodiments, sub-combinations, and subsets thereof. Those of skill in the art will understand how to make and use the present invention after understanding the present disclosure. The present invention, in its various embodiments, configurations, and aspects, includes providing devices in the absence of items not depicted and/or described herein or in various embodiments, configurations, or aspects hereof, including in the absence of such items as may have been used in previous devices, e.g., for improving performance, achieving ease and\or reducing cost of implementation.

The foregoing discussion has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures to those claimed, whether or not such alternate, interchangeable and/or equivalent structures disclosed herein, and without intending to publicly dedicate any patentable subject matter.

We claim:

1. A craft kit of separate parts adapted for assembly into an article, comprising:
a frame part in the form of a handgun shape, the frame part including a stock, a barrel, a hammer, and a trigger integral therewith,
a pair of grip-shaped parts, each fixedly attachable via first fastening means to a respective side of the stock on the frame part,
a pair of semi-cylindrical shaped firing cylinder halves, each firing cylinder half attachable via second fastening means different from the first to a respective side of the frame part, wherein the frame part, grip-shaped parts and firing cylinder halves, together with the first and second fastening means, comprise the entirety of the assembled article.

2. The craft kit of claim 1, wherein the first fastening means includes at least one of nails, brads, screws, hook-and-loop fasteners, rivets, and magnets adapted to secure the grip-shaped parts to the stock.

3. The craft kit of claim 1, wherein the first fastening means includes an adhesive applied to opposed contact faces of one or both of the stock and grip-shaped part.

4. The craft kit of claim 1, wherein
each firing cylinder half includes a central bore formed partially into an inner side face thereof,
the frame part includes a central hole formed completely therethrough, the hole adapted to be aligned with the bores in the firing cylinder halves, and
the second fastening means includes an elongate dowel insertable through the frame central hole with ends of the dowels captured in corresponding opposed bores of the firing cylinder halves, securing the firing cylinder halves to the frame part.

5. The craft kit of claim 4, wherein the second fastening means further includes an adhesive applied to one or more of the dowel, within the central hole in the frame part, within the bores of the firing cylinder halves, on the inner side faces of the cylinder halves, and on a portion of the frame part to be in contact with the inner side face of the cylinder half.

6. The craft kit of claim 1, wherein at least one of the frame part, grip-shaped parts and firing cylinder halves are composed of wood or a wood-based material.

7. The craft kit of claim 1, wherein at least one of the frame part, grip-shaped parts and firing cylinder halves are composed of a plastic or synthetic material.

8. The craft kit of claim 1, wherein at least one of the frame part, grip-shaped parts and firing cylinder halves are composed of a rubber or elastomeric material.

9. A craft kit for assembling a non-lethal, handgun shaped article, comprising:
a frame part shaped in the form of a handgun profile,
a pair of grip-shaped parts fixedly attachable to a handle portion of the frame part,
a pair of semi-cylindrical shaped firing cylinder halves, each attachable to a respective side of the frame part, and
a set of instructions for putting the frame part, grip-shaped parts and firing cylinder halves together.

10. The craft kit of claim 9, further comprising fastening means for fixedly securing the grip-shaped parts and firing cylinder halves to the frame part.

11. The craft kit of claim 10, wherein the frame part, grip-shaped parts, firing cylinder halves, and fastening means comprise the entirety of the assembled non-lethal, handgun shaped article.

12. The craft kit of claim 9, wherein each grip-shaped part includes one or more pre-drilled holes therethrough, the fastening means including at least one or more of nails, brads, screws, and rivets adapted to secure the grip-shaped parts to the stock via the pre-drilled holes.

13. The craft kit of claim 9, wherein the fastening means comprises hook-and-loop fasteners or magnetic elements.

14. The craft kit of claim 9, wherein
each firing cylinder half includes a central bore formed partially therethrough,
the frame part includes a central hole formed completely therethrough, the hole adapted to be aligned with the bores in the firing cylinder halves, and
the fastening means further includes an elongate dowel insertable through the frame central hole between the opposed bore holes, securing the firing cylinder halves to the frame part.

15. The craft kit of claim 9, wherein the fastening means includes an adhesive applied to opposed contact faces of one or more of the frame part, the grip-shaped parts and inner side faces of the cylinder halves.

16. A method for assembling a non-lethal, handgun shaped article, comprising:
coupling each of a pair of handle grips to either side of a first portion of a frame part designed in the form of a handgun shape, and
attaching each of a pair of semi-cylindrical shaped firing cylinder halves to respective sides at a second portion of the frame part in order to complete assembly of the non-lethal, handgun shaped article.

17. The method of claim 16, wherein
the first portion is a stock of the frame part,
each grip-shaped part includes one or more pre-drilled holes therethrough, and
coupling further includes inserting at least one fastener through the pre-drilled holes and into the stock to fixedly secure the grip parts to the stock.

18. The method of claim 16, wherein coupling further includes:
applying an adhesive to one or both of a surface of the grip part and an opposed surface of the frame part at the first portion, and
pressing the grip parts to the frame part for a given period of time to cure the adhesive.

19. The method of claim 16, wherein
each firing cylinder half includes a central bore formed partially therein,
the frame part includes a central hole formed completely therethrough, the hole adapted to be aligned with the bores in the firing cylinder halves, and
attaching includes inserting an elongate dowel through the frame central hole so that each end portion of the dowel is captured in a respective bore the fixedly secure the firing cylinder halves to the frame part.

20. The method of claim 16, wherein attaching includes:
applying an adhesive to one or both of a surface of the cylinder half and an opposed surface of the frame part at the second portion, and
pressing the cylinder halves to the frame part for a given period of time to cure the adhesive.
